(19) United States
(12) Patent Application Publication
(10) Pub. No.: US 2014/0099532 A1
(43) Pub. Date: Apr. 10, 2014

(54) SECONDARY BATTERY

(71) Applicant: SAMSUNG SDI CO., LTD., Yongin-si (KR)

(72) Inventor: Ho-Jae CHO, Yongin-si (KR)

(73) Assignee: SAMSUNG SDI CO., LTD., Yongin-si (KR)

(21) Appl. No.: 13/803,369

(22) Filed: Mar. 14, 2013

Related U.S. Application Data
(60) Provisional application No. 61/711,712, filed on Oct. 9, 2012.

(51) Int. Cl. H01M 2/02

(52) U.S. Cl. CPC H01M 2/02
USPC 429/163

(57) ABSTRACT

A secondary battery that includes a battery case having a first surface; and a cover that covers at least one portion of the first surface. In the secondary battery, the cover includes at least one extension member that covers at least one portion of a second surface vertically connected to the first surface of the battery case. The second surface of the battery case is provided with a mounting portion on which the extension member is mounted, and the mounting portion is provided to be recessed inward from a peripheral portion of the mounting portion.

### CLAIM OF PRIORITY

This application claims priority to and the benefit of Provisional Application No. 61/711,712 filed on 9 Oct., 2012, in the United States Patent and Trademark Office, the entire content of which is incorporated herein by reference.

### BACKGROUND OF THE INVENTION

1. Field of the Invention

An aspect of the present invention generally relates to a secondary battery.

2. Description of the Related Art

Recently, a secondary battery using a non-aqueous liquid electrolyte has variously used as a power source of portable electronic devices. As the portable electronic devices are used in various fields, demands on the secondary battery are rapidly increased. The secondary battery can be reversibly charged/discharged a plurality of times, and thus is economically and environmentally efficient. Accordingly, the use of the secondary battery is encouraged.

As a decrease in the size and weight of the electronic devices is required, a decrease in the size and weight of the secondary battery is also required. Accordingly, a variety of studies have been conducted to develop a secondary battery of which size and weight are reduced while maintaining safety and reliability without lowering the capacity of the secondary battery.

The above information disclosed in this Related Art section is only for enhancement of understanding of the background of the invention and therefore it may contain information that does not form the prior art that is already known to a person of ordinary skill in the art.

### SUMMARY OF THE INVENTION

Embodiments provide a secondary battery of which size is reduced using a new member.

Embodiments also provide a secondary battery of which volume is reduced as compared with its capacity.

According to an aspect of the present invention, there is provided a secondary battery, that may include a battery case to accommodate an electrode assembly; a mounting portion in a second surface of the battery case, the mounting portion may be a recess in the second surface of the battery case; and a cover to cover a first surface of the battery case having at least one extension member extending from the cover. The at least one extension member couples to the mounting portion of the battery case holding the cover to the battery case.

A thickness of the at least one extension member may correspond to a depth of the recess of the mounting portion.

A thickness, height and width of the at least one extension member may correspond to a depth, height and width of the recess of the mounting portion .

The mounting portion in the second surface of the battery case may be located adjacent to the first surface of the battery case.

The cover may also include a base portion having a shape corresponding to the first surface of the battery case.

The at least one extension member may extend from an edge of the base portion.

The at least one extension member may further include: a first extension member extending from said edge of the base portion of the cover; and a second extension member extending from another edge of the base portion of the cover.

The mounting portion may further include: a first mounting portion in a side of the second surface of the battery case; and a second mounting portion in another side of the second surface of the battery case.

The thickness, height and width of the first extension member may correspond to a depth, height and width of a recess of the first mounting portion, and the thickness, height and width of the second extension member may correspond to a depth, height and width of a recess of the second mounting portion.

The thickness of the battery case may be thinner where the mounting portion is located than anywhere else in the battery case.

The at least one extension member and the mounting portion may have a rectangular shape.

The at least one extension member and the mounting portion may have a trapezoid shape. This trapezoid shape may have two parallel sides and two non-parallel sides.

Upon coupling of the at least one extension member to the mounting portion an external surface of the at least one extension member may be flush with the external surface of the battery case.

The at least one extension member may include at least one first fastening portion, and the mounting portion includes at least one second fastening portion.

The at least one first fastening portion may be a groove-projection coupling or a hook coupling, and the second fastening portion may be a groove-projection coupling or a hook coupling.

The first fastening portion may attach to the second fastening portion upon coupling of the at least one extension member to the mounting portion.

The secondary battery may further include a label surrounding the battery case and extension member.

The extension member may take the form of a skirt extending from the base portion so as to define a space accommodating coupling of the mounting portion.

The mounting portion may be defined by a portion of the second surface adjacent to the first surface that is recessed to form a portion of the second surface that is not adjacent to the first surface.

The recess of the mounting portion may be a stepped recess.

As described above, according to the present invention, it is possible to provide a secondary battery of which size is reduced using a new member.

Further, it is possible to provide a secondary battery of which volume is reduced as compared with its capacity.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view of a secondary battery according to an embodiment of the present invention.

FIG. 2A is a perspective view showing the secondary battery and a label according to the embodiment of the present invention.

FIG. 2B is an exploded perspective view of the secondary battery of FIG. 1.

FIG. 3A is a perspective view of a cover according to the embodiment of the present invention.

FIG. 3B is a perspective view showing a lower portion of the cover of FIG. 3A.

FIG. 4 is a perspective view showing a battery case and an electrode assembly, shown in FIG. 1.

FIG. 5A is a sectional view taken along line I-I of FIG. 2A.

FIG. 5B is a sectional view taken along line II-II of FIG. 4.

FIG. 6 is a perspective view of a cover according to another embodiment of the present invention.

FIG. 7 is a perspective view of a battery case according to the embodiment of the present invention.

FIG. 8 is a sectional view showing a state in which the cover and the battery case are coupled together.

FIG. 9 is a perspective view showing a cover and a battery case according to still another embodiment of the present invention.

FIG. 10 is a perspective view showing a cover and a battery case according to still another embodiment of the present invention.

FIG. 11 is a perspective view showing a lower portion of the cover of FIG. 10.

FIG. 12 is a sectional view taken along line I-I of FIG. 2A according to still another embodiment of the present invention illustrating a stepped mounting portion.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on another element or be indirectly on another element with one or more intervening elements interposed therebetween. Also, when an element is referred to as being “connected to” another element, it can be directly connected to another element or be indirectly connected to the another element with one or more intervening elements interposed therebetween. Hereinafter, like reference numerals refer to like elements.

The example embodiments are described more fully hereinafter with reference to the accompanying drawings. The inventive concept may, however, be embodied in many different forms and should not be construed as limited to the example embodiments set forth herein. In the drawings, the sizes and relative sizes of layers and regions may be exaggerated for clarity.

It will be understood that when an element or layer is referred to as being “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like or similar reference numerals refer to like or similar elements throughout. As used herein, the term “and/or” includes any and all combinations of one or more of the associated listed items.

It will be understood that, although the terms first, second, third etc. may be used herein to describe various elements, components, regions, layers, patterns and/or sections, these elements, components, regions, layers, patterns and/or sections should not be limited by these terms. These terms are only used to distinguish one element, component, region, layer pattern or section from another region, layer, pattern or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross sectional illustrations that are schematic illustrations of illustratively idealized example embodiments (and intermediate structures) of the inventive concept. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, an exemplary embodiment of the present invention will be described in detail with reference to the accompanying drawings.

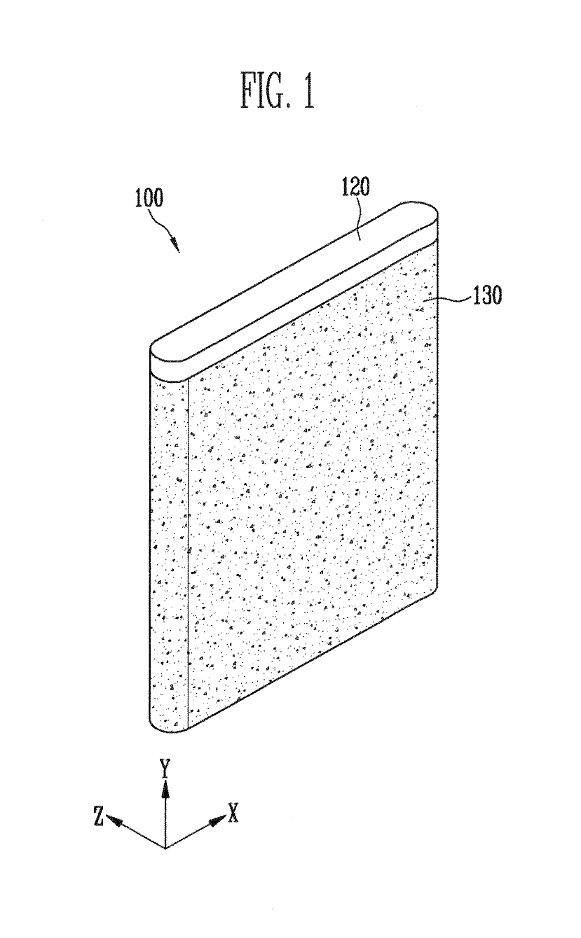

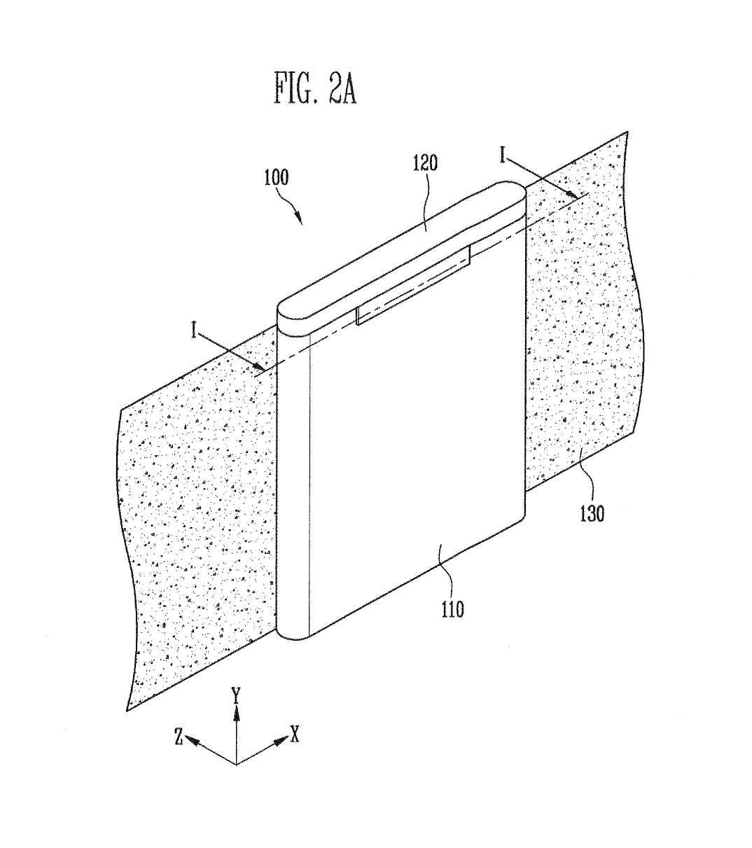

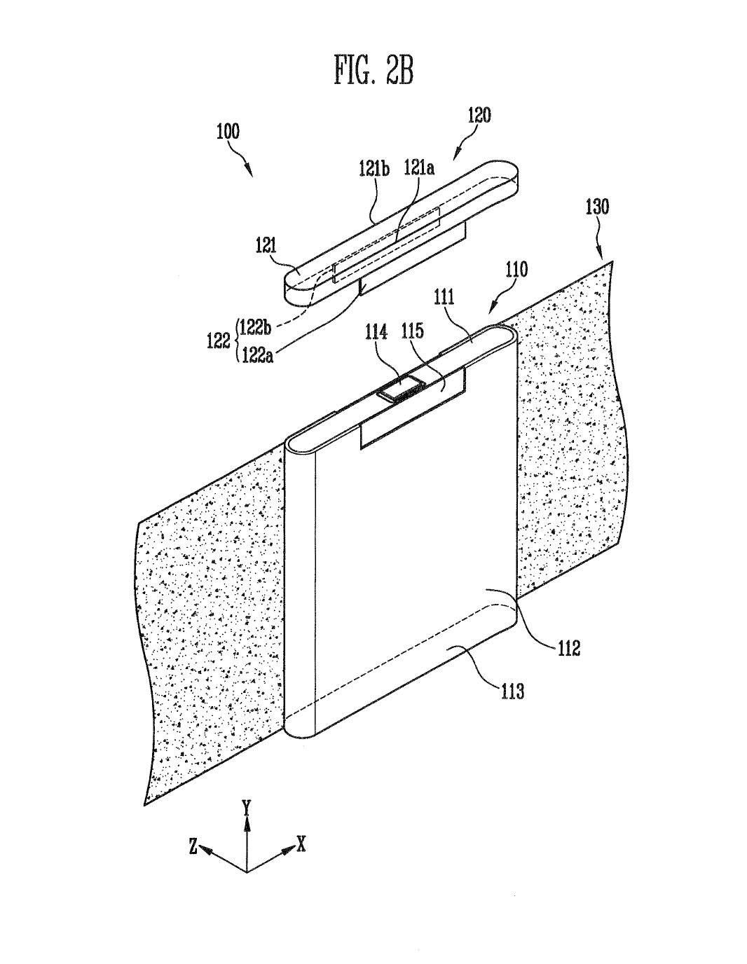

FIG. 1 is a perspective view of a secondary battery according to an embodiment of the present invention. FIG. 2A is a perspective view showing the secondary battery and a label according to the embodiment of the present invention. FIG. 2B is an exploded perspective view of the secondary battery of FIG. 1.

The secondary battery 100 according to this embodiment includes a battery case 110 having a first surface 111, and a cover 120 that covers at least a portion of the first surface 111. The cover 120 includes at least one extension member 122 that covers at least one portion of a second surface 112 of the battery case 110, which is vertically connected to the first surface 111 of the battery case 110. The second surface 112 includes a mounting portion 115 on which the extension member 122 is mounted, and the mounting portion 115 may be provided to be recessed inward from a peripheral portion of the mounting portion 115.

The secondary battery 100 further includes a label 130 that covers the second surface 112 of the secondary battery 100, and the label 130 may be provided to cover the extension member 122 of the cover 120. After the cover 120 is mounted on the first surface 111 of the battery case 110, the label 130 may be provided to surround the second surface 112 of the battery case 110. In this case, the extension member 122 of the cover 120 is extended to cover the at least one portion of the second surface 112, and therefore may be fixed together with the second surface 112 by the label 130. The extension member 122 is inserted into the mounting portion 115 provided to be recessed inward from the peripheral portion thereof, and the label 130 firmly fixes the extension member 122 together with the second surface 112, so that it is possible to improve the coupling between the cover 120 and the battery case 110. For example, the label 130 may be composed of a sheet-shaped insulating member and an adhesive member formed on the insulating member. Hereinafter, the configuration according to this embodiment will be described in detail with reference to FIGS. 1 to 2B.

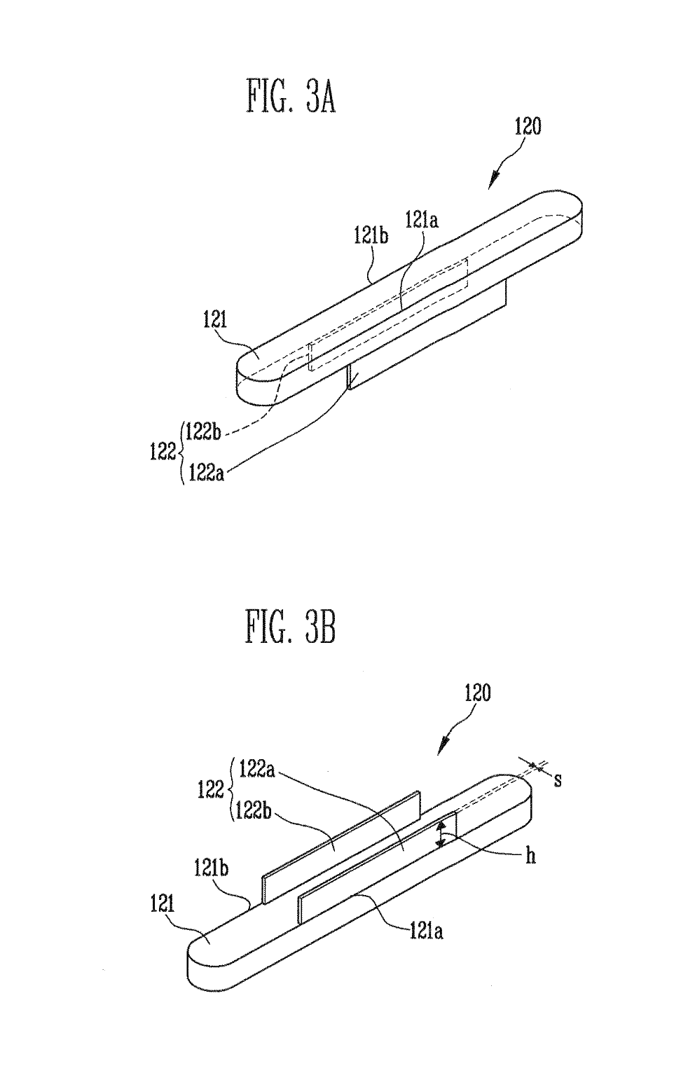

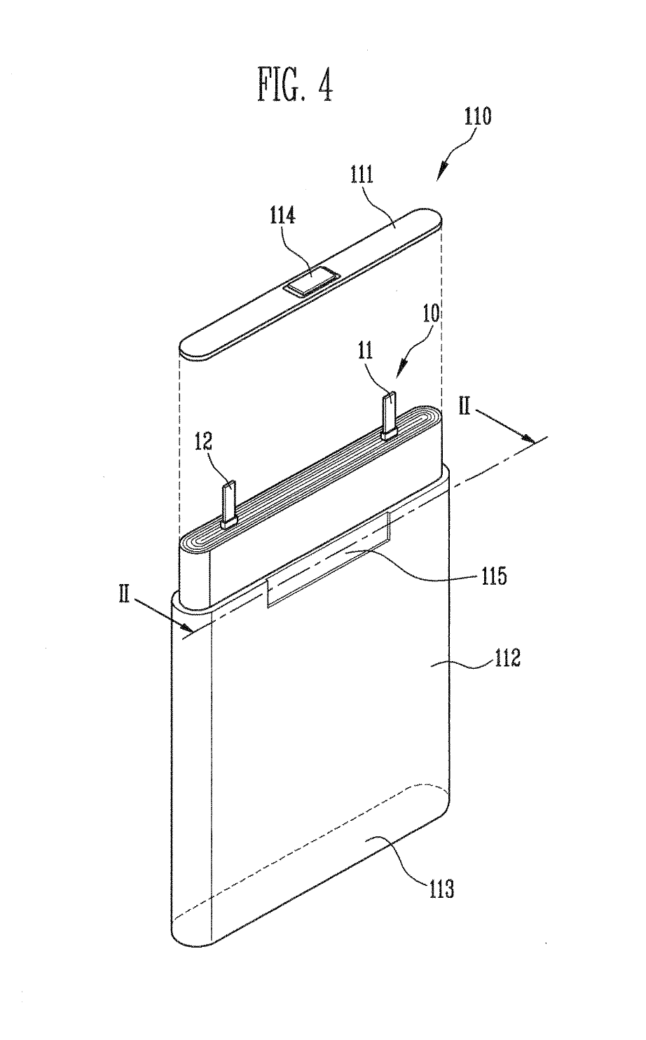

FIG. 3A is a perspective view of the cover according to the embodiment of the present invention. FIG. 3B is a perspective view showing a lower portion of the cover of FIG. 3A. FIG. 4 is a perspective view showing the battery case and an electrode assembly, shown in FIG. 1.

Referring to FIGS. 3A and 3B, the cover 120 may include a base portion 121 provided in a shape corresponding to the first surface 111, and at least one extension member 122 extended from the base portion 121 so as to cover at least one portion of the second surface 112. The extension member 122 includes first and second extension members 122a and 122b respectively extended from one end 121a and the other end 121b of the base portion 121. The first and second extension members 122a and 122b may be provided in parallel with each other.

The base portion 121 is provided in parallel with the first surface 111 so as to be mounted on the first surface 111 of the battery case 110, and the first and second extension members 122a and 122b may be provided vertical to the base portion 121 from the one end 121a and the other end 121b, which are both ends of the base portion 121. For example, the first and second extension members 122a and 122b may be vertically extended from the base portion 121 so as to be parallel with the second surface 112 vertical to the first surface 111. The first and second extension members 122a and 122b may be provided so that outer surfaces of the first and second extension members 122a and 122b are parallel with those of the one and the other ends of the base portion 121. Thus, the outer surfaces of the base portion 121 and the first or second extension member 122a and 122b at the side of the cover 120 can be provided on the approximately same plane without any protruded portion.

The interval between the outer surfaces of the first and second extension members 122a and 122b may correspond to the maximum thickness of the battery case 120. Since the battery case 120 is inserted between the first and second extension members 122a and 122b, the interval between outer surfaces of the pair of mounting portions 115 in the battery case 120 may be provided to correspond to the interval between inner surfaces of the first and second extension members 122a and 122b.

The thickness s of each of the first and second extension members 122a and 122b may be 0.1 to 0.2 mm. In a case where the thickness s of each of the first and second extension members 122a and 122b is less than 0.1 mm, it is difficult to manufacture the cover 120 through injection molding. In a case where the thickness s of each of the first and second extension members 122a and 122b exceeds 0.2 mm, it is difficult to provide a space in which each of the first and second extension members 122a and 122b can be inserted into the mounting portion 115, and therefore, each of the first and second extension members 122a and 122b may be further protruded from the peripheral portion of the mounting portion 115. Further, the thickness of the portion at which the mounting portion 115 is provided in the second surface 112 is too thin, and therefore, the strength of the battery case 110 may be lowered.

The longitudinal length h parallel with the second surface in each of the first and second extension members 122a and 122b may be extended up to the longitudinal length of the battery case 110 from a minimum of 3 mm. In a case where the longitudinal length h is less than 3 mm, each of the first and second extension members 122a and 122b cannot be stably mounted on the mounting portion 115, and hence the cover 120 is easily detached from the battery case 110. Therefore, the cover 120 cannot be stably fixed to the battery case 110. In a case where the longitudinal length h exceeds the longitudinal length of the battery case 110 along the battery case 110, the entire length of the secondary battery 100 may be unnecessarily increased.

Referring to FIG. 4, an electrode assembly 10 and an electrolyte may be provided in the battery case 110. The electrode assembly 10 may be manufactured by winding or stacking positive and negative electrode plates having different polarities and a separator interposed between the positive and negative electrode plates. The electrolyte facilitates the movement of current between the positive and negative electrode plates, and positive and negative electrode tabs 11 and 12 provided to the positive and negative electrode plates may be electrically connected to the first surface 111 and an electrode terminal 114 provided to the first surface 111, respectively. For example, the battery case 110 may be made of aluminum, steel or the like. For example, the thickness of the battery case 110 may be 0.2 to 0.5 mm.

The electrode terminal 114 is provided to the first surface 111, and the battery case 110 may further include a third surface 113 opposite to the first surface 111. The first and third surfaces 111 and 113 are provided in parallel with each other, and the second surface 112 is provided vertical to the first and third surfaces 111 and 113 so that the first and third surfaces 111 and 113 can be connected through the second surface 112. The cover 120 may be provided with one or more covers so as to cover at least one of the first and third surfaces 111 and 113. Although it has been described in this embodiment that the cover 120 is provided only on the first surface 111 for convenience of illustration, the present invention is not limited thereto. The second surface 112 may be provided with one or more mounting portions 115, and the mounting portion 115 may be provided in a shape corresponding to the extension member 122 mounted on the mounting portion 115. For example, the first and second extension members 122a and 122b may be provided to have sizes corresponding to each other, and accordingly, the mounting portions 115 may also be provided to have shapes corresponding to each other.

The base portion 121 of the cover 120 may be provided in a planar shape or may be further provided with a space formed in the inside of the base portion 121. That is, the base portion 121 may be further provided with a space formed in the opposite direction of the first and second extension members 122a and 122b, based on the surfaces of the base portion 122 to which the respective first and second extension members 122a and 122b are connected. The space may be used as a space in which a portion protruded from the first surface 111, a separate protection device or the like is accommodated.

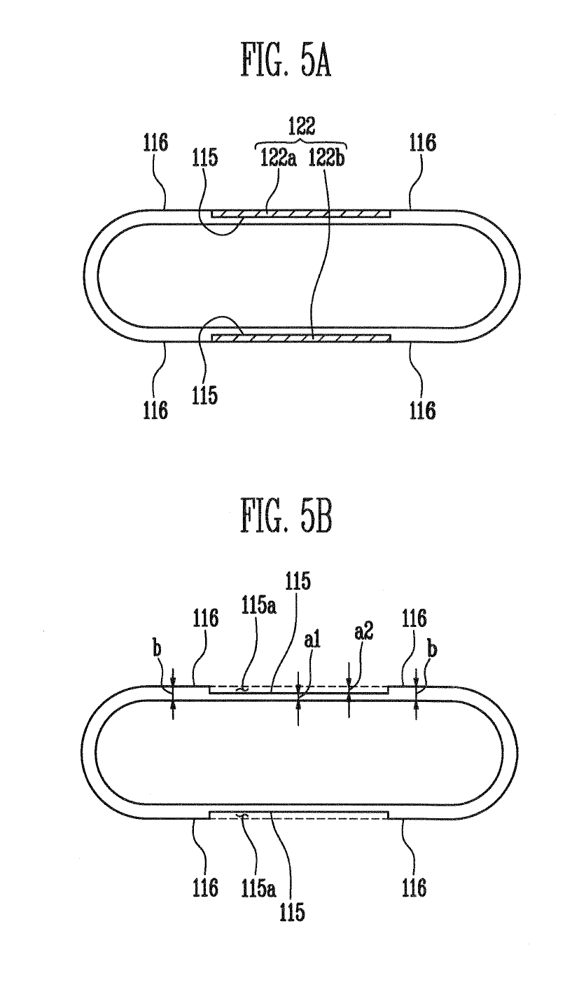

FIG. 5A is a sectional view taken along line I-I of FIG. 2A. FIG. 5B is a sectional view taken along line II-II of FIG. 4.

Referring to FIGS. 5A and 5B, the outer surface of the second surface may be provided to be recessed from a peripheral portion 116 of the mounting portion 115 so that the mounting portion 115 has a portion 115a recessed inward, and the inner surface of the second surface may be provided to be flat. That is, the thickness a1 of the mounting portion 115 may be provided thinner than that b of the peripheral portion 116, and the depth a2 of the recessed portion 115a on the mounting portion 115 may be provided to correspond to that of each of the first and second extension members 122a and 122b. Thus, the recessed portion 115a on the mounting portion 115 can be offset by each of the first and second extension members 122a and 122b, and the mounting portion 115 having each of the first and second extension members 122a and 122b mounted thereon can form the same plane with the peripheral portion 116 of the mounting portion 115.

In a secondary battery, it is very important that the size and weight of the secondary battery are reduced while maintaining the capacity of the secondary battery. Therefore, the safety and reliability of the secondary battery should be equally maintained while reducing the size and weight of the secondary battery. In the secondary battery according to this embodiment, the extension member is provided to the cover that covers the first surface, so that the cover can be firmly fixed to the battery case. Further, the extension member is provided without any protruding portion by the mounting portion provided to the battery case, and thus it is possible to prevent an increase of volume regardless of the capacity of the secondary battery.

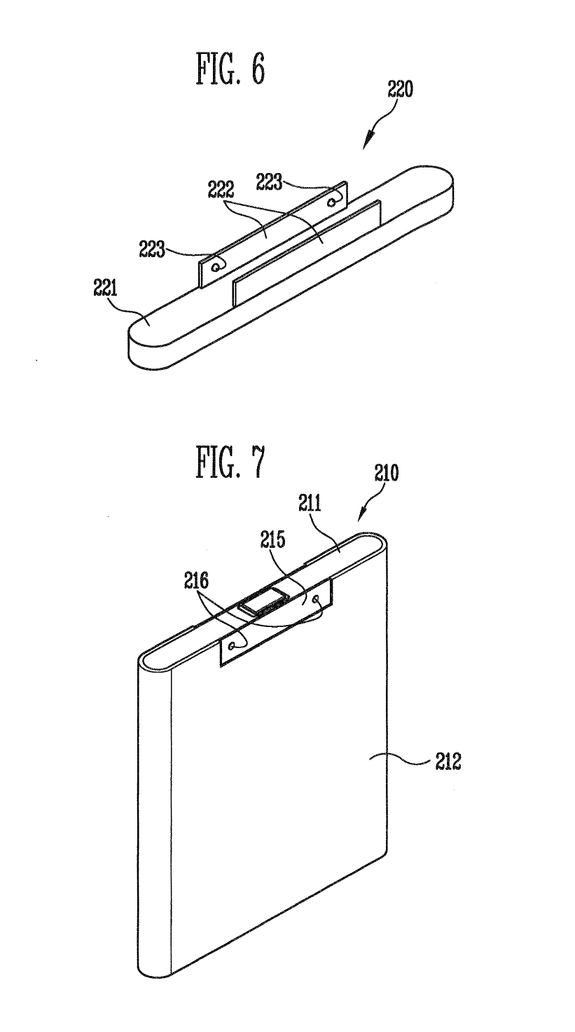

Hereinafter, other embodiments of the present invention will be described with reference to FIGS. 6 to 12. Contents of these embodiments, except the following contents, are similar to those of the embodiment described with reference to FIGS. 1 to 5B, and therefore, their detailed descriptions will be omitted.

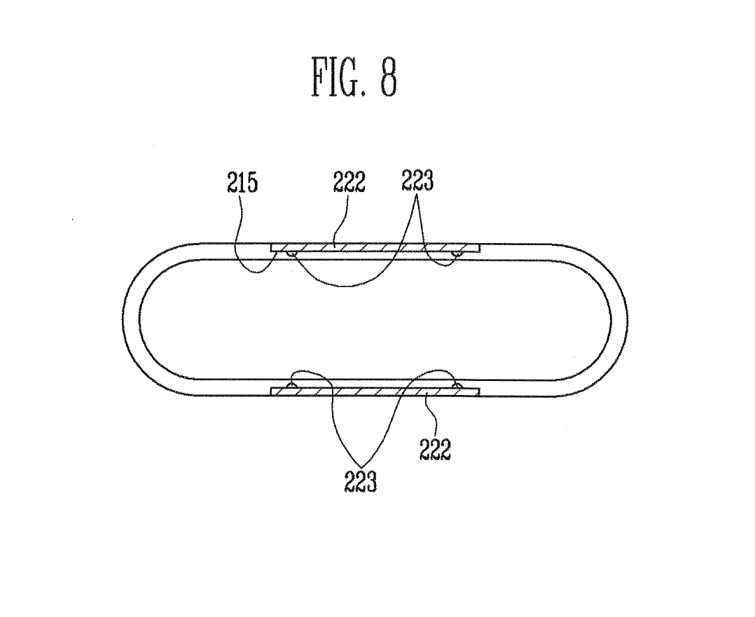

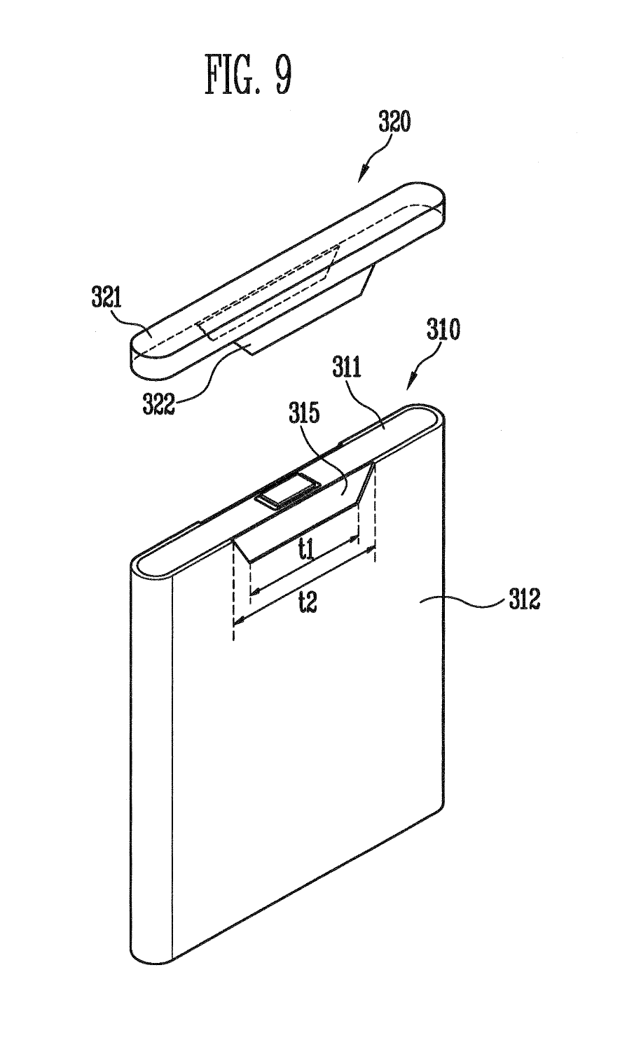

FIG. 6 is a perspective view of a cover according to another embodiment of the present invention. FIG. 7 is a perspective view of a battery case according to the embodiment of the present invention. FIG. 8 is a sectional view showing a state in which the cover and the battery case are coupled together.

Referring to FIGS. 6 to 8, in the secondary battery according to this embodiment, at least one portion of the battery case 210, e.g., the cover 220 that covers a first surface 211 may include a base portion 212 and at least one extension member 222 extended from the base portion 212, and a second surface 212 of the battery case 210 may be provided with a mounting portion 215 recessed inward so that the extension member 222 is mounted on the mounting portion 215. The mounting portion 215 is provided to be recessed inward, so that after the extension member 222 is mounted on the mounting portion 215, the thickness of the mounting portion 215 is approximately similar to that of a peripheral portion of the mounting portion 215.

First and second fastening portions 223 and 216 may be provided in the extension member 222 and the mounting portion 215, respectively. That is, the first fastening portion 223 may be provided in an inner surface of the extension member 222, and the second fastening portion 216 fastened to the first fastening portion 223 may be provided in an outer surface of the mounting portion 215. For example, the first and second fastening portions 223 and 216 may be fastened through groove-projection coupling or hook coupling. After the battery case 210 is inserted between a pair of extension members 222 of the cover 220, the cover 220 is moved toward a lower portion of the battery case 210, so that the battery case 210 and the cover 220 can be coupled to each other. In this case, the first fastening portion 223 provided in the extension member 222 and the second fastening portion 216 provided in the mounting portion 215 can be easily fastened to each other, and the cover 220 can be firmly fixed to the battery case 210.

FIG. 9 is a perspective view showing a cover and a battery case according to still another embodiment of the present invention.

Referring to FIG. 9, at least one portion of a mounting portion 315 provided in a second surface 312 of the battery case 310 may be diagonally provided. That is, the mounting portion 315 may be provided in a tapered shape so that the width of the mounting portion 315 is gradually decreased in a direction distant from a first surface 311 of the battery case 310. Therefore, in the mounting portion 315, the length t2 of the width of a portion adjacent to the first surface 311 may be provided longer than that t1 of the width of a portion most distant from the first surface 311.

The cover 320 may include a base portion 321 corresponding to the first surface 311, and at least one extension member 322 extended in the direction of the battery case 310 from both end portions of the base portion 321. The cover 320 may be coupled to the battery case 310 on the first surface 311 of the battery case 310. In this case, the extension member 322 may be provided in a shape corresponding to the mounting portion 315. For example, the extension member 322 may be provided to have a tapered shape in which the width of an upper portion of the extension member 322 is narrower than that of a lower portion of the extension member 322. Thus, when the cover 320 and the battery case 310 are coupled to each other, the most narrow width of the extension member 322 is inserted in the widest width of the mounting portion 315, and accordingly, the extension member 322 can be easily provided to the mounting portion 315. Further, the contact area between the extension member 322 and the mounting portion 315 is increased, so that it is possible to increase the coupling between the extension member 322 and the mounting portion 315.

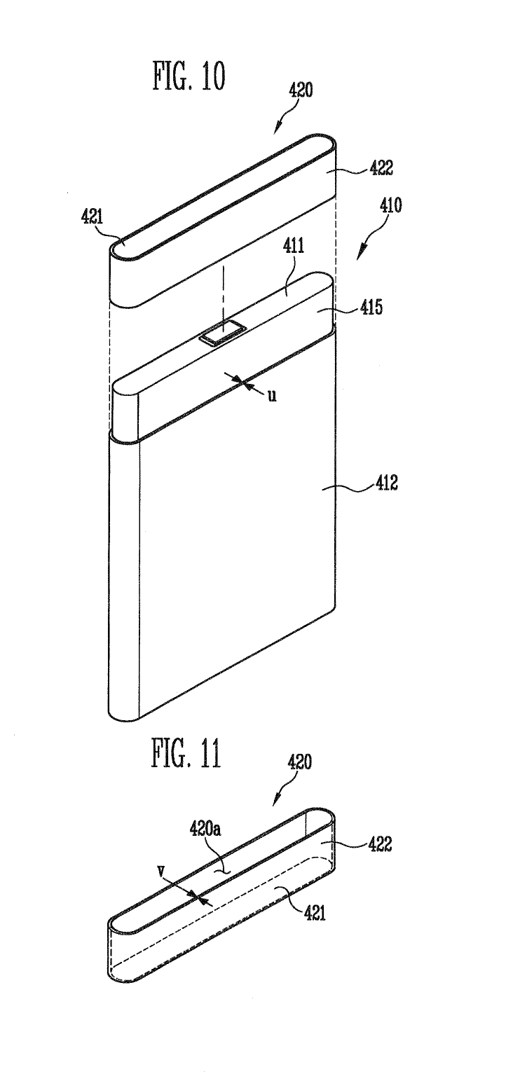

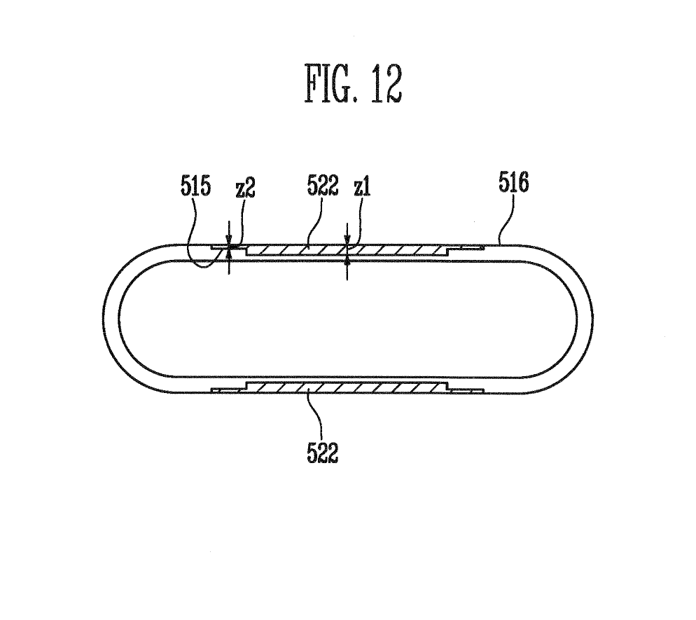

FIG. 10 is a perspective view showing a cover and a battery case according to still another embodiment of the present invention. FIG. 11 is a perspective view showing a lower portion of the cover of FIG. 10.

In the battery case 410 according to this embodiment, an upper portion of the battery case 410 may be inserted into the cover 420. The cover 420 coupled to the battery case 410 may include a base portion 421 opposite to a first surface 411 of the battery case 410, and a extension member 422 integrally provided along the outer circumferential surface of the base portion 421. That is, the cover 420 is provided with an accommodating portion 420a that is a space formed by the base portion 421 and the extension member 422, and at least one portion of the battery case 410 may be inserted into the accommodating portion 420a.

A mounting portion 415 corresponding to the extension member 422 may be provided at a portion connected to the first surface 411 from a second surface 412. The portion of the second surface 412 adjacent to the first surface 411 of the battery case 410 may be provided to be recessed from the portion at which the second surface is not adjacent to the first surface 411. Since the mounting portion 415 is provided in a shape corresponding to the extension member 422, the mounting portion 415 may be entirely provided at the upper portion of the battery case 410 adjacent to the first surface 411 of the battery case 410. Therefore, the thickness of the upper portion of the second surface 412 in the direction vertical to the first surface 411 may be provided thinner than that of the lower portion of the second surface 412.

FIG. 12 is a sectional view taken along line I-I of FIG. 2A according to still another embodiment of the present invention illustrating a stepped mounting portion.

Referring to FIG. 12, the outer surface of the second surface may be provided to be recessed from a peripheral portion 516 of the mounting portion 522 so that the mounting portion 522 has a stepped recessed portions 515 and 522, and the inner surface of the second surface may be provided to be flat. That is, the thickness of the mounting portion 522 may be provided thinner than the thickness of peripheral portion 516. Further, the depth z2 of the stepped recess portion 515 is less than the depth z1 of the stepped recess portion 522, and the depth z1 and z2 of the recessed portions 522 and 515 may be provided to correspond to that of each of the first and second extension members 122a and 122b. Thus, the recessed portion 115a on the mounting portion 115 can be offset by each of the first and second extension members 122a and 122b, and the mounting portion 115 having each of the first and second extension members 122a and 122b mounted thereon can form the same plane with the peripheral portion 516 of the mounting portion 115.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A secondary battery, comprising:
a battery case to accommodate an electrode assembly ;
a mounting portion in a second surface of the battery case, said mounting portion being a recess in the second surface of the battery case ; and
a cover to cover a first surface of the battery case having at least one extension member extending from the cover,
wherein the at least one extension member couples to the mounting portion of the battery case holding the cover to the battery case .

2. The secondary battery recited in claim 1, wherein a thickness of the at least one extension member corresponds to a depth of the recess of the mounting portion.

3. The secondary battery recited in claim 1, wherein a thickness, height and width of the at least one extension member corresponds to a depth, height and width of the recess of the mounting portion.

4. The secondary battery recited in claim 1, wherein said mounting portion in the second surface of the battery case is located adjacent to the first surface of the battery case.

5. The secondary battery recited in claim 1, wherein the cover further comprises:
a base portion having a shape corresponding to the first surface of the battery case.

6. The secondary battery recited in claim 5, wherein the at least one extension member extends from an edge of the base portion.

7. The secondary battery recited in claim 6, wherein the at least one extension member further comprises:
a first extension member extending from said edge of the base portion of the cover; and
a second extension member extending from another edge of the base portion of the cover.

8. The secondary battery recited in claim 7, wherein the mounting portion further comprises:
a first mounting portion in a side of the second surface of the battery case; and
a second mounting portion in another side of the second surface of the battery case.

9. The secondary battery recited in claim 8, wherein a thickness, height and width of the first extension member corresponds to a depth, height and width of a recess of the first mounting portion, and a thickness, height and width of the second extension member corresponds to a depth, height and width of a recess of the second mounting portion .

10. The secondary battery recited in claim 1, wherein a thickness of the battery case is thinner where the mounting portion is located than anywhere else in the battery case.

11. The secondary battery recited in claim 3, wherein the at least one extension member and the mounting portion have a rectangular shape.

12. The secondary battery recited in claim 3, wherein the at least one extension member and the mounting portion have a trapezoid shape, said trapezoid shape having two parallel sides and two non-parallel sides.

13. The secondary battery recited in claim 1, wherein upon coupling of the at least one extension member to the mounting portion an external surface of the at least one extension member is flush with said second surface of the battery case.

14. The secondary battery recited in claim 1, wherein the at least one extension member includes at least one first fastening portion, and the mounting portion includes at least one second fastening portion .

15. The secondary battery recited in claim 14, wherein said at least one first fastening portion is a groove-projection coupling or a hook coupling, and the second fastening portion is a groove-projection coupling or a hook coupling.

16. The secondary battery recited in claim 15, wherein the first fastening portion attaches to the second fastening portion upon coupling of the at least one extension member to the mounting portion.

17. The secondary battery recited in claim 1, further comprising:
a label surrounding the battery case and extension member.

18. The secondary battery recited in claim 5, wherein the extension member takes the form of a skirt extending from the base portion so as to define a space accommodating coupling of the mounting portion.

19. The secondary battery recited in claim 1, wherein the mounting portion is defined by a portion of the second surface adjacent to the first surface that is recessed to form a portion of the second surface that is not adjacent to the first surface.

20. The secondary battery recited in claim 1, wherein the recess of the mounting portion further comprises a stepped recess.
